(19) United States
(12) Patent Application Publication
(10) Pub. No.: US 2005/0284929 A1
(43) Pub. Date: Dec. 29, 2005

(54) Portable storage apparatus

(76) Inventor: Lang-Sheng Tsu, Miao-Li County (TW)

Correspondence Address: Hoffman, Warnick & D'Alessandro LLC, Three E-Comm Square, Albany, NY, 12207, US

(21) Appl. No.: 11/167,494

(22) Filed: Jun. 27, 2005

(30) Foreign Application Priority Data
Jun. 28, 2004 (TW) 093118855

(51) Int. Cl. G06K 5/00

(52) U.S. Cl. 235/380

(57) ABSTRACT

This invention provides a portable storage apparatus to process a data of the memory card by the card reader. Storage apparatus comprises a receiving interface, a memory module, an activating device and a controller. The receiving interface is connected to card reader for transmitting or deleting data. The memory module is connected to the receiving interface for storing data. The activating device generates a plurality of triggering signals. The controller is connected to the receiving interface, the memory module and the activating device for selectively storing the data in the memory card to the memory module or deleting the data in the memory card according to the plurality of triggering signals.

### BACKGROUND OF THE INVENTION

1. Field of the Invention

The present invention relates to a storage apparatus, and more particularly, to a portable storage apparatus.

2. Description of the Prior Art

The portable storage apparatus of the prior art, such as the so-called portable hard disks, are not installed with a Central Processing Unit (CPU). Therefore, when the data in the memory card is to be read, the USB/L-Link of the portable hard disk must first be connected to the personal computer (PC) or Notebook; the card reader is then connected to the USB/L-Link of the PC or Notebook, then the card reader can read, delete, or download data in the memory card by the assistance of the CPU in the PC or Notebook.

Generally, the capacity of the memory card of the digital camera is often insufficient; the capacity of the memory cards in the current market can be 128MB/256MB/512MB etc. In accordance with the prior art, the deleting and downloading of the data in a memory card or a flash drive by the portable hard disk are through the USB/IEEE 1394 interface in the PC or Notebook. Thus, the user is unable to download, store or delete the data in the memory card (such as SD, SM, MSCF, Micro Drive) if the user does not bring a Notebook and cannot continually use the memory card once the memory capacity is full.

Thus, one objective of the present invention is to provide a portable storage apparatus to solve the above-mentioned problems.

### SUMMARY OF THE INVENTION

An objective of the present invention is to provide a portable storage apparatus for storing the data in the memory card or for deleting the data in the memory card directly.

The present invention provides a portable storage apparatus for processing the data in the memory card through the card reader. The storage apparatus comprises a receiving interface, a memory module, an activating device and a controller. The receiving interface is connected to the card reader to transmit or delete data. The memory module is connected to the receiving interface to store data. The activating device is used for generating a plurality of triggering signals. The controller is connected to the receiving interface, the memory module and the activating device and selectively stores the data of the memory card into the memory module or deletes the data of the memory card according to the plurality of triggering signals.

The present invention provides a portable storage apparatus for processing the data in the memory card. The storage apparatus comprises a card reader, a receiving interface, a memory module, an activating device and a controller. The card reader reads the data in the memory card. The receiving interface is connected to the card reader to transmit data. The memory module is connected to the receiving interface to store data. The activating device is used for generating a plurality of triggering signals. The controller is connected to the receiving interface, the memory module, and the activating device, and it selectively stores the data of the memory card into the memory module or deletes the data of the memory card according to the plurality of triggering signals.

The portable storage apparatus of the present invention is able to download, store and delete the data in the memory card, flash drive and other memory devices independently without the assistance of a PC, a Notebook or other computing device. Therefore, the user can use a small, cheap and convenient portable storage apparatus with ultra large memory capacity to download, store or delete the data in the memory card anytime, anywhere. In other words, the function and spirit of the invention is like enlarging the capacity of the memory card (128MB/256MB/512MB) to a storage device with ultra large capacity.

The advantage and spirit of the invention may be understood by the following recitations together with the appended drawings.

### BRIEF DESCRIPTION OF THE APPENDED DRAWINGS

FIG. 1 is the system block diagram of the portable storage apparatus of the present invention.

FIG. 2 is the system block diagram of another portable storage apparatus of the present invention.

### DETAILED DESCRIPTION OF THE INVENTION

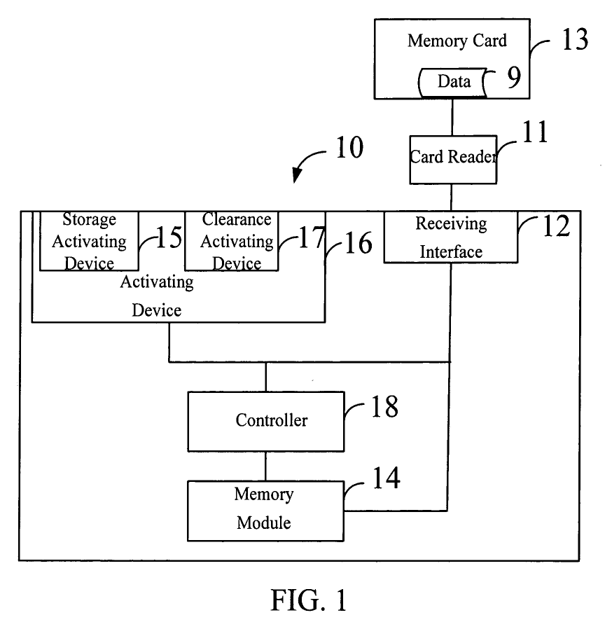

Referring to FIG. 1, FIG. 1 is the system block diagram of the portable storage apparatus 10 of the present invention. In a preferred embodiment, the portable storage apparatus 10 of the present invention processes the data 9 in a memory card 13 through a card reader 11. The storage apparatus 10 comprises a receiving interface 12, a memory module 14, an activating device 16 and a controller 18. The receiving interface 12 is connected to the card reader 11 to transmit or delete the data 9. In the preferred embodiment, the receiving interface 12 is a USB interface; in another preferred embodiment, the receiving interface 12 is an IEEE 1394 interface. The memory module 14 is connected to the receiving interface 12 to store the data 9. The activating device 16 is used for generating a plurality of triggering signals. The controller 18 is connected to the receiving interface 12, the memory module 14 and the activating device 16 for selectively storing the data 9 in the memory card 13 to the memory module 14 or for deleting the data 9 in the memory card 13, according to the plurality of triggering signals. The electrical power (not shown) of the portable storage apparatus can be supplied from the AC or DC current of a battery or an external power supply.

In the preferred embodiment, the activating device 16 comprises a storage activating device 15 to generate a storage triggering signal and a clearance activating device 17 to generate a clearance triggering signal. When the controller 18 receives the storage triggering signal, the controller 18 stores the data 9 in the memory card 13 to the memory module 14 through the receiving interface 12. When the controller 18 receives the clearance triggering signal, the controller 18 deletes the data 9 stored in the memory card 13 through the receiving interface 12. In a preferred embodiment, the storage activating module 15 and the clearance activating module 17 are both buttons.

The portable storage apparatus 10 further comprises a display apparatus (not shown in FIG. 1) for receiving and displaying a display signal from the controller 12, so as to show the state of the data.

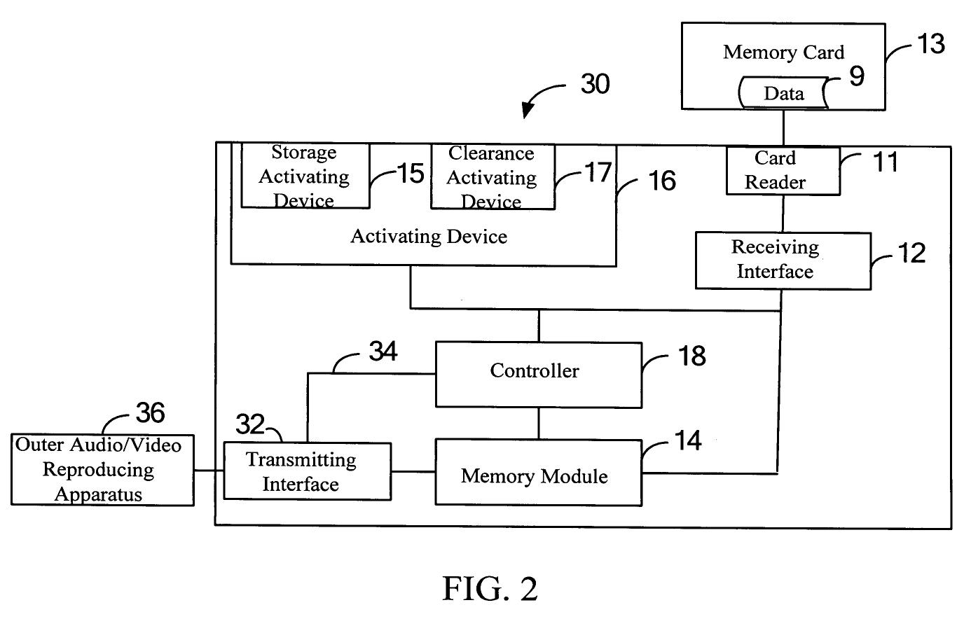

Referring to FIG. 2, FIG. 2 is the system block diagram of another portable storage apparatus 30 of the present invention. In the other preferred embodiment, the portable storage apparatus 30 of the present invention processes the data 9 in the memory card 13. The storage apparatus 30 comprises a card reader 11, a receiving interface 12, a memory module 14, an activating device 16 and a controller 18. The card reader 11 is used for reading or deleting the data 9 in the memory card 13. The receiving interface 12 is connected to the card reader 11 to transmit or delete the data 9 in the memory card 13. In a preferred embodiment, the receiving interface 12 is a USB interface; in another preferred embodiment, the receiving interface 12 is an IEEE1394 interface. The memory module 14 is connected to the receiving interface 12 for storing the data 9. The activating device 16 is used for generating a plurality of triggering signals. The controller 18 is connected to the receiving interface 12, the memory module 14, and the activating device 16 for selectively storing the data 9 in the memory card 13 into the memory module 14 or for deleting the data 9 in the memory card 13, according to the plurality of triggering signals. In the preferred embodiment of the FIG. 2, the card reader 11 is installed in the portable storage apparatus 30; therefore, there is no need for the portable storage apparatus 30 to be connected to another external card reader 11 to read the data is stored in various types of memory card 13. The user is capable of storing and deleting the data in the memory card 13 by directly using the portable storage apparatus 30 of the present invention. The electrical power (not shown) of the portable storage apparatus is supplied by the AC or DC current of a battery or an external power supply.

In the preferred embodiment shown in FIG. 2, the activating device 16 comprises a storage activating device 15 that generates a storage triggering signal and a clearance activating device 17 that generates a clearance triggering signal. When the controller 18 receives the storage triggering signal, the controller 18 stores the data 9 in the memory card 13 to the memory module 14. When the controller 18 receives the clearance triggering signal, the controller 18 deletes the data 9 in the memory card 13. In a preferred embodiment, the storage activating module 15 and the clearance activating module 17 are both buttons.

The portable storage apparatus 30 further comprises a display apparatus (not shown in FIG. 2) for receiving and displaying a display signal from the controller 18, so as to show the state of the data.

The portable storage apparatus 30 further comprises a transmitting interface 32. The controller 18 is connected to the memory module 14 and the transmitting interface 32 in a loop; the transmitting interface 32, according to a transmitting signal 34 outputted from the controller 18, transmits the data in the memory module 14 to an external audio/video reproducing apparatus 36. The audio/video reproducing apparatus 36 is a rear projection television. The transmitting interface can be a USB interface, an IEEE 1394 interface or a I²C interface in different preferred embodiments. There is no limit on the transmitting interface 32 in the present invention. Any interfaces able to be connected to the audio/video reproducing apparatus 36 and to transmit the data can be the transmitting interface 32 of the present invention.

The portable storage apparatus of the present invention can be installed in a plasma television or a rear projection television. The data in the memory card is read by a card reader or downloaded to the storage apparatus via the USB/IEEE 1394 interface; thus, the user can access large quantity of data conveniently, and this improves the disadvantage of the prior art which can only read the data in the memory card by the card reader installed in the television and not able to store the data in the plasma television or the rear projection television.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A portable storage apparatus for processing data in a memory card via a card reader, the storage apparatus comprising:
a receiving interface connected to the card reader for transmitting or deleting the data;
a memory module connected to the receiving interface for storing the data;
an activating device for generating a plurality of triggering signals;
a controller connected to the receiving interface, the memory module and the activating device for selectively storing the data in the memory card to the memory module or deleting the data in the memory card according to the plurality of triggering signals; and
a power supply for providing power to the portable storage apparatus.

2. The portable storage apparatus of claim 1, wherein the activating device comprises a storage activating module for generating a storage triggering signal, and the controller stores the data in the memory card into the memory module after receiving the storage triggering signal.

3. The portable storage apparatus of claim 2, wherein the storage activating module is a button.

4. The portable storage apparatus of claim 1, wherein the activating device comprises a clearance activating module for generating a clearance triggering signal, and the controller deletes the data in the memory card after receiving the clearance triggering signal.

5. The portable storage apparatus of claim 4, wherein the clearance activating module is a button.

6. The portable storage apparatus of claim 1, wherein the receiving interface is a USB interface or an IEEE1394 interface.

7. The portable storage apparatus of claim 1, wherein the portable storage apparatus further comprises a display device for receiving and displaying a display signal from the controller to show the state of the data.

8. A portable storage apparatus for processing data in a memory card, the portable storage apparatus comprising:
a card reader for reading or deleting the data in the memory card;
a receiving interface connected to the card reader for transmitting or deleting the data;
a memory module connected to the receiving interface for storing the data;
an activating device for generating a plurality of triggering signals;
a controller connected to the receiving interface, the memory module and the activating device for selectively storing the data in the memory card to the memory module or deleting the data in the memory card according to the plurality of triggering signals; and
a power supply for providing power to the portable storage apparatus.

9. The portable storage apparatus of claim 8, wherein the activating device comprises a storage activating module for generating a storage triggering signal, and the controller stores the data in the memory card into the memory module after receiving the storage triggering signal.

10. The portable storage apparatus of claim 9, wherein the storage activating module is a button.

11. The portable storage apparatus of claim 8, wherein the activating device comprises a clearance activating module for generating a clearance triggering signal, and the controller deletes the data in the memory card after receiving the clearance triggering signal.

12. The portable storage apparatus of claim 11, wherein the clearance activating module is a button.

13. The portable storage apparatus of claim 8, wherein the receiving interface is a USB interface or an IEEE1394 interface.

14. The portable storage apparatus of claim 8, wherein the portable storage apparatus further comprises a display device for receiving and displaying a display signal from the controller to show the state of the data.

15. The portable storage apparatus of claim 8, further comprising a transmitting interface wherein the transmitting interface is connected to the controller and the memory module, and the transmitting interface transmits the data in the memory module to an audio and video reproducing device according to a transmitting signal outputted from the controller.

16. The portable storage apparatus of claim 15, wherein the audio and video apparatus is a rear projection television.

17. The portable storage apparatus of claim 15, wherein the transmitting interface is a USB interface, an IEEE1394 interface or an I²C interface.
